(19) United States
(12) Patent Application Publication
(10) Pub. No.: US 2024/0008680 A1
(43) Pub. Date: Jan. 11, 2024

(54) System and Method for a Kamado Cooker that Looks Like an Iconic Kettle-style Grill

(71) Applicant: Spider Grills, LLC, Athens, GA (US)

(72) Inventors: Joseph Pruitt, Athens, GA (US); Kyle Aasness, Athens, GA (US)

(73) Assignee: Spider Grills, LLC, Athens, GA (US)

(21) Appl. No.: 17/859,880

(22) Filed: Jul. 7, 2022

(51) Int. Cl. A47J 37/07

(52) U.S. Cl. CPC A47J 37/0704; A47J 37/0786

(57) ABSTRACT

Exemplary embodiments of a kamado cooker that looks like an iconic kettle-style grill are disclosed. Certain embodiments comprise a ceramic kettle base having an exterior surface and an interior surface and defining an aperture at its bottom, a ceramic lid hinged to the ceramic kettle base, a kettle support bowl defining an inner concave surface and an outer convex surface and a central aperture, a kettle securing collar defining an inner concave surface and an outer convex surface and a central aperture, and a plurality of legs mechanically received by a plurality of leg support extensions associated with the outer convex surface of the kettle support bowl.

### BACKGROUND

The present invention relates to outdoor grilling and smoking solutions and, more particularly, to a novel system and method for providing a kamado cooker that looks like an iconic kettle-style grill.

Grilling or smoking food with a kamado cooker is becoming more and more mainstream with outdoor grilling enthusiasts. Kamado cookers are defined by their heavy, ceramic construction and have become synonymous with an “egg shaped” or ovoid body style. As popular as kamado cookers have become, however, their popularity wanes in comparison to the iconic kettle-styled grill, such as a typical Weber® grill as would be recognized in the art. Over the years, grilling enthusiasts have come to love and identify with the iconic look and shape of a kettle-styled grill. And so, it is envisioned that kettle-styled grill users may prefer a kamado cooker that presents the aesthetic of an iconic kettle-styled grill.

Therefore, there is a need in the art for a system and method of providing a kamado cooker that looks like, or otherwise presents an aesthetic of, a kettle-styled grill.

### SUMMARY

Exemplary embodiments of a kamado cooker that looks like an iconic kettle-style grill are disclosed. Certain embodiments are configured to specifically resemble a Weber® charcoal grill.

An exemplary embodiment of a kamado cooker that looks like an iconic kettle-style grill comprises a ceramic kettle base having an exterior surface and an interior surface and defining an aperture at its bottom, a ceramic lid hinged to the ceramic kettle base, a kettle support bowl defining an inner concave surface and an outer convex surface and a central aperture, a kettle securing collar defining an inner concave surface and an outer convex surface and a central aperture, and a plurality of legs mechanically received by a plurality of leg support extensions associated with the outer convex surface of the kettle support bowl. Notably, when the kettle support bowl is mounted to the exterior surface of the ceramic kettle base, and the kettle securing collar is mounted to the interior surface of the ceramic kettle base, the kettle support bowl central aperture and the kettle securing collar central aperture and the ceramic kettle base aperture are concentric such that an ash bucket mounted beneath the convex surface of the kettle support bowl covers the concentric apertures. The ceramic kettle base, kettle support bowl, and kettle securing collar may be mechanically assembled by fasteners that extend through the ceramic kettle base, thereby providing a sturdy means for receiving the plurality of legs.

Further embodiments may comprise a plurality of sidewall brackets mounted to the interior surface of the ceramic kettle base, each defining an upper support surface and a lower support surface. The sidewall brackets may be mounted to the ceramic kettle base by fasteners extending through the ceramic kettle base. Advantageously, a charcoal basket may be suspended from the lower support surfaces of the sidewall brackets and a cooking grate may be rested upon the upper support surfaces of the sidewall brackets. Moreover, one or more heat deflector plates may be rested upon the lower support surfaces of the sidewall brackets.

### BRIEF DESCRIPTION OF THE DRAWINGS

In the drawings, like reference numerals refer to like parts throughout the various views unless otherwise indicated. For reference numerals with letter character designations such as “105A” or “105B” or “105C,” the letter character designations may differentiate two like parts or elements present in the same figure. Letter character designations for reference numerals may be omitted when it is intended that a reference numeral to encompass all parts having the same reference numeral in all figures.

FIG. 1 illustrates an exemplary embodiment of a kamado cooker that presents, according to the solution, the look or aesthetic of an iconic kettle-styled grill;

FIG. 2 is a partially exploded view of the exemplary embodiment shown in FIG. 1;

FIG. 3 is a fully exploded view of the exemplary embodiment shown in FIG. 1;

FIG. 4 is another view of the exemplary embodiment shown in FIG. 1, illustrated with the domed kettle lid removed to reveal an upper interior of the kettle base;

FIG. 5 is a close-up view of a portion of the upper interior of the kettle base; and

FIG. 6 is a cutaway or sectioned view of the exemplary embodiment shown in FIG. 1.

### DETAILED DESCRIPTION

Various embodiments, aspects and features of the present invention encompass a system and method for a kamado cooker that looks like an iconic kettle-style grill. As one of ordinary skill in the art would understand and recognize, kettle-styled grills are generally manufactured of aluminum or thin gauge steel. As such, kettle-style grills are relatively light in weight, with a kettle that is easily supported by three or four tubular legs bolted to the base of the kettle. By contrast, the sheer weight of a typical kamado cooker dictates that the ovoid body of the cooker is usually removably rested in a sturdy support structure.

To use a kettle-style grill or a kamado cooker, charcoal is placed in the base of the cooker or kettle of the grill and ignited. A cooking grate is suspended over the top of the charcoal. Thermal energy generated by the charcoal radiates upward toward the grate and cooks any food item placed thereon. To control temperature and rate of burn, both kettle-styled charcoal grills and kamado cookers usually include a somewhat crude, manual damper-type control. Some incorporate the damper on the top of a lid that mates to and over the lower kettle or cooker base. Other kamado cookers and kettle-styled grills, however, such as a KamadoJoe® brander cooker or a Weber® branded kettle-style grill, incorporate a damper at the bottom of the cooker or kettle (often in addition to a damper on the lid), thereby providing means for control of air directly to, and through, the charcoal. An ash bucket feature may be incorporated over the lower dampers in the base of a kettle-styled grill in order to capture ash expelled from the kettle.

Unlike kettle-styled grills known in the art, kamado cookers are constructed from ceramic. Consequently, kamado cookers may be extremely heavy, certainly when compared to the aluminum or steel construction of a kettle-styled grill. As such, for kettle-styled grills known in the art, a manufacturer of kettle-styled grills seeking to incorporate the cooking advantages of a kamado cooker into its product cannot simply replace the aluminum or steel kettle with a lookalike kettle made from ceramic — it would be too heavy to be supported by the tubular legs that are bolted to the kettle of an iconic kettle-style grill. As will be better understood from the illustrations and description that follow, embodiments of the solution provide a means by which a kettle-styled grill may incorporate a heavy, ceramic kettle without losing the iconic look associated with kettle-styled grills.

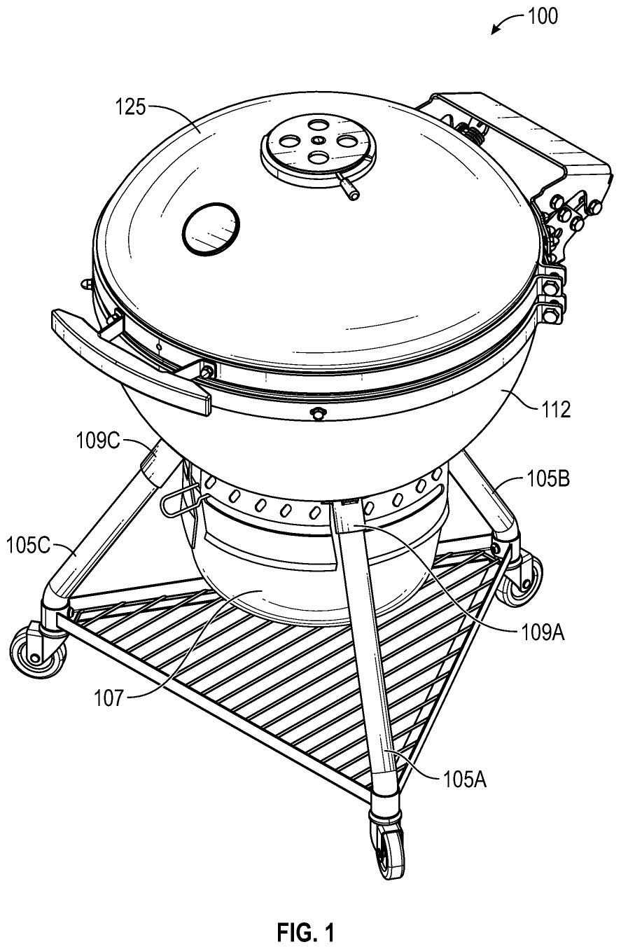

FIG. 1 illustrates an exemplary embodiment of a kamado cooker 100 that presents, according to the solution, the look or aesthetic of an iconic kettle-styled grill. The kamado cooker 100 includes a kettle made up of a kettle base 112 and a lid 125, both constructed from ceramic material. Three tubular legs 105 are received into complementary support extensions 109 associated with the underside, convex surface of a kettle support bowl 110 (not shown in the FIG. 1 illustration). As will become clearer from subsequent illustrations, the outer surface of the kettle base 112 nests into the concave surface of the kettle support bowl 110. An ash bucket 107 is suspended beneath the kettle base 112.

As can be seen in the FIG. 1 illustration, the kamado cooker 100 according to the solution resembles an iconic kettle-styled grill normally constructed of relatively light-weight metal. The details of the novel construction of the solution will become more apparent from a review of the illustrations that follow.

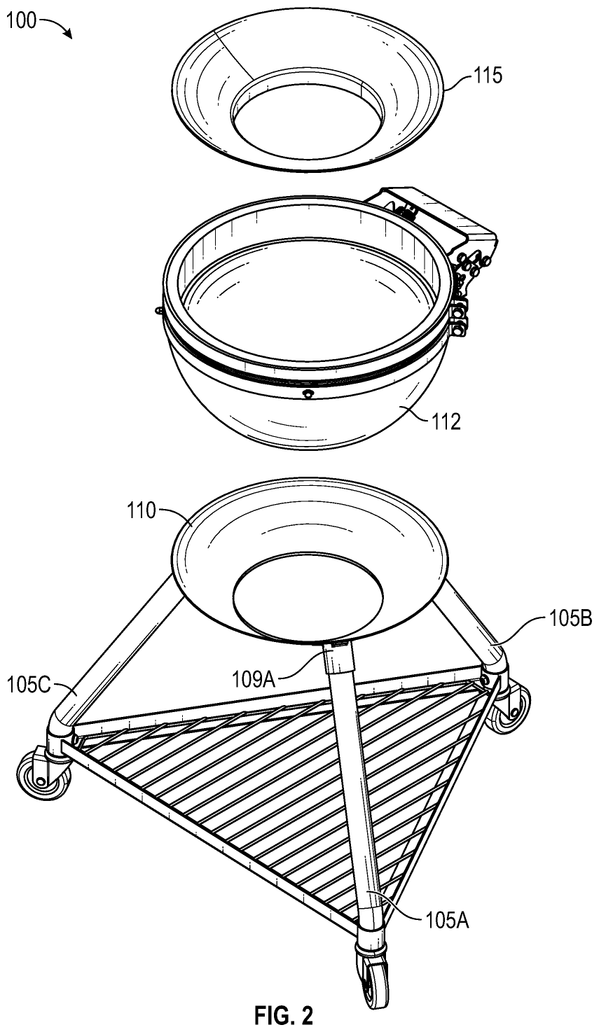

FIG. 2 is a partially exploded view of the exemplary embodiment 100 shown in FIG. 1. The lid 125 has been removed, leaving only kettle base 112. As previously described, the lower outer surface of the kettle base 112 is configured to be received by, and rest in, the concave surface of kettle support bowl 110. Further, and as can be understood from the exploded illustration, a kettle securing collar 115 is configured to nest into the lower inner surface of the kettle base 112, thereby “sandwiching” a lower portion of the kettle base 112 between the kettle securing collar 115 and the kettle support bowl 110. Through-bolts or other fasteners may then be installed through the kettle securing collar 115, kettle base 112, and kettle support bowl 110 (fasteners not illustrated). Advantageously, with fasteners secured through the kettle securing collar 115, kettle base 112, and kettle support bowl 110, the heavy weight of the ceramic kettle base 112 (and lid 125) may be safely and robustly supported by the legs 105.

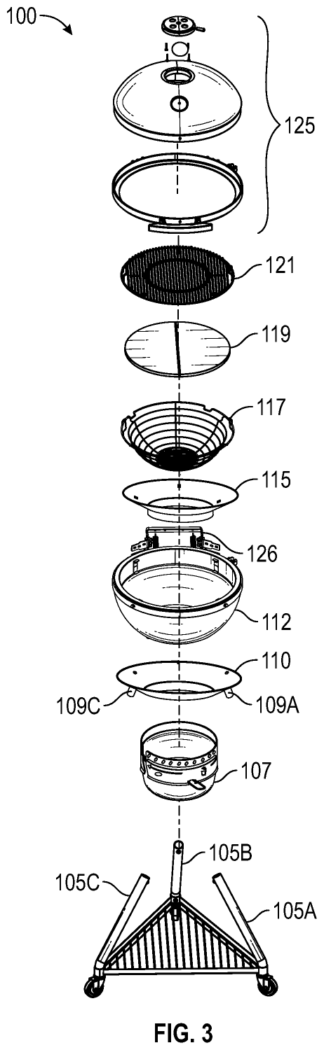

FIG. 3 is a fully exploded view of the exemplary embodiment 100 shown in FIG. 1.

As can be understood from the FIG. 3 illustration, the lower exterior convex surface of the kettle base 112 nests into the upper concave surface of the kettle support bowl 110 while the lower convex surface of the kettle securing collar 115 nests into the inner concave surface of the kettle base 112. The kettle securing collar 115 is mechanically secured to the kettle support bowl 110 via fasteners extended through the kettle base 112, thereby establishing a mechanically secured collar assembly of the kettle securing collar 115, kettle base 112, and kettle support bowl 110. A plurality of support extensions 109 extend from the lower convex surface of the kettle support bowl 110 and are configured to receive legs 105. Notably, the number of support extensions 109 may equal the number of legs 105.

An ash bucket and damper assembly 107 is positioned beneath the kettle support bowl 110. Components interior to the kettle base 112 are a coal basket 117, a pair of half-moon heat deflector plates 119, and a cooking grate 121. Components 117, 119, and 121 are exemplary in nature—all embodiments of the solution may not include all components 117, 119 and 121, may include components additional to components 117, 119 and 121, or may include any combination thereof. When the cooker is fully assembled, ceramic lid 125 mates to kettle base 112 via hinge 126, as would be understood by one of ordinary skill in the art.

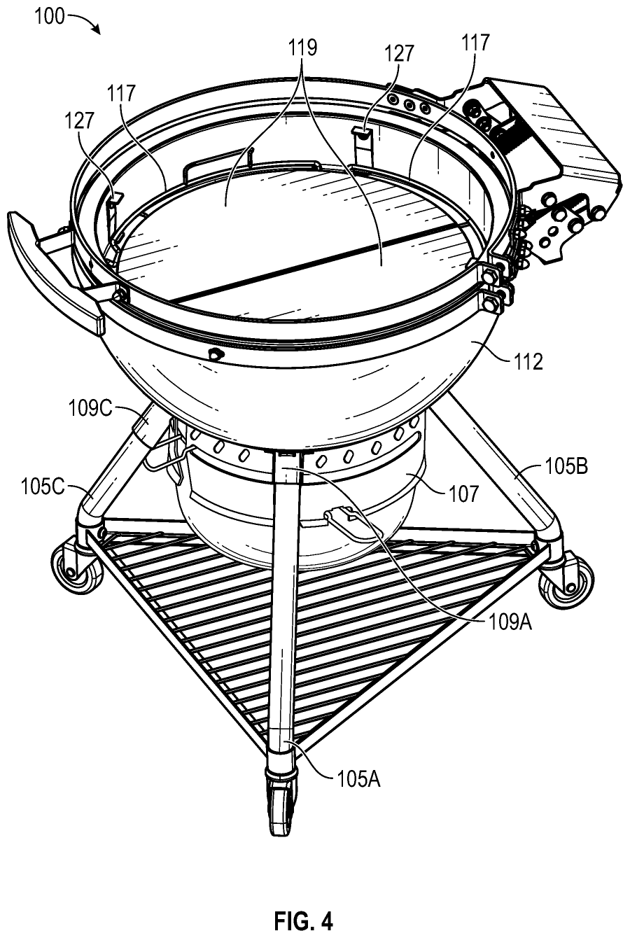

FIG. 4 is another view of the exemplary embodiment 100 shown in FIG. 1, illustrated with the domed kettle lid 125 removed to reveal an upper interior of the kettle base 112. The legs 105 are received into the support extensions 109. Each leg 105 is associated with a complementary leg extension 109. In the exemplary embodiment, leg 105A is received into leg support extension 109A, leg 105B is received into leg support extension 109B, and leg 105C is received into leg support extension 109C. The exemplary embodiment 100 features three legs 105 and three leg support extensions 109, however, it is envisioned that alternative embodiments of the solution may incorporate more than three legs.

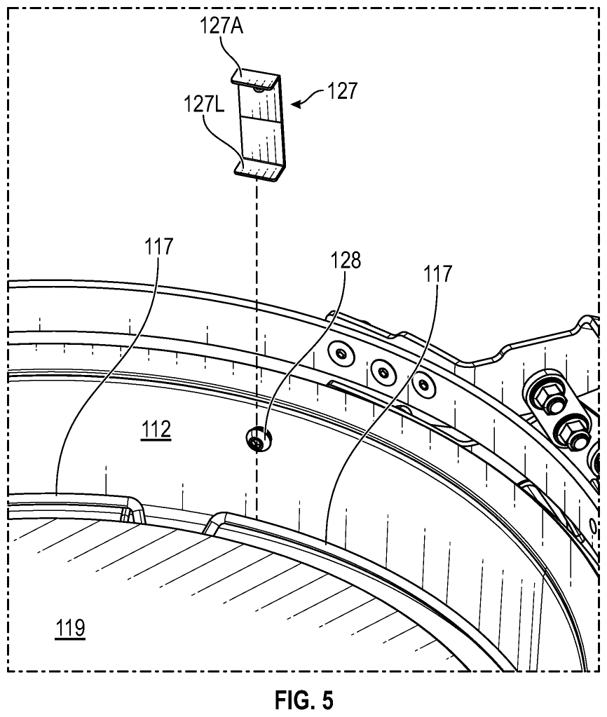

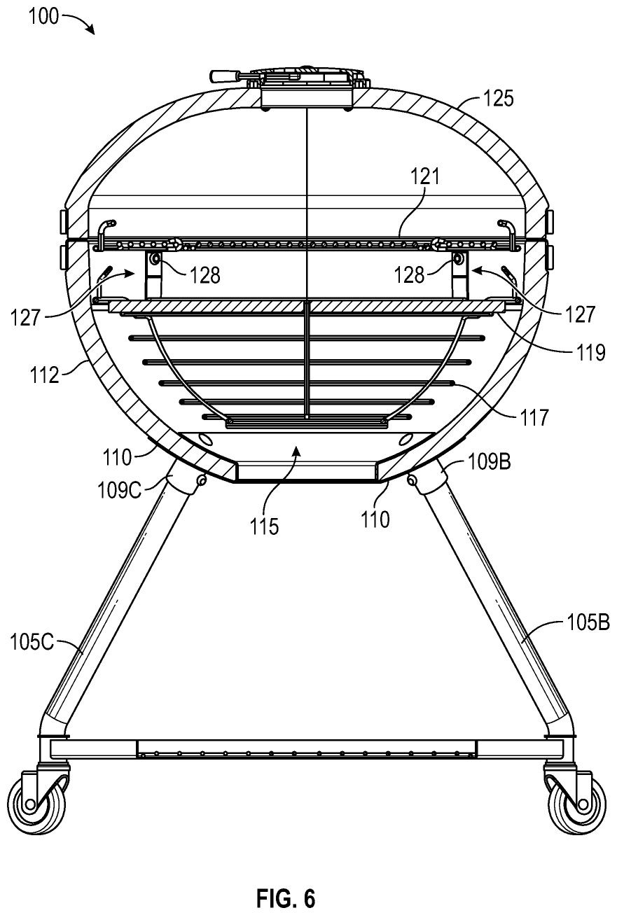

As can be seen in the FIG. 4 illustration, and more clearly in the FIG. 5 close-up illustration of a portion of the upper interior of the kettle base 112, a plurality of sidewall brackets 127 are mounted around the upper interior circumference of the kettle base 112. Each sidewall bracket 127 defines an upper support surface 127U and a lower support surface 127L. The lower support surfaces 127L of the various brackets 127 cooperate to support both the half-moon heat deflector plates 119 and hanging of the coal basket 117 within the interior of the kettle base 112 (see FIG. 6 illustration). Similarly, the upper support surfaces 127U of the various brackets 127 cooperate to support the cooking grate 121 in suspension over the deflector plates 119 (see FIG. 6 illustration). For each bracket 127, a fastener 128, which may be in the form of a through-bolt, extends through the bracket 127 and the sidewall of the kettle base 112 in order to mechanically secure the bracket 127 to the interior surface of the kettle base 112. The brackets 127 provide for easy and efficient removal and replacement of the various components that reside within the interior of the kettle base 112.

Turning now to FIG. 6, illustrated is a cutaway or sectioned view of the exemplary embodiment 100 shown in FIG. 1. The cutaway illustration of FIG. 6 shows the brackets 127 supporting the cooking grate 121 and the charcoal basket 117 and deflector plates 119, as previously described.

The cutaway illustration of FIG. 6 also demonstrates the relationship of the kettle securing collar 115, kettle base 112, and kettle support bowl 110 that forms the collar assembly. The kettle base 112 defines a relatively large aperture at its lowest point. The kettle support bowl 110 includes a complementary aperture that is concentric with that of the kettle base 112 when the kettle support bowl 110 is mounted to the kettle base 112. Similarly, the kettle securing collar 115 also defines an aperture that is complementary to, and concentric with, the aperture of the kettle base 112 when the kettle securing collar 115 is mounted within the kettle base 112. Advantageously, the collar assembly (defined by the mechanically mated kettle securing collar 115, kettle base 112, and kettle support bowl 110) provides for a sturdy and secure means by which the legs 105 may support the heavy, ceramic cooker.

A kamado cooker that looks like an iconic kettle-style grill, according to the solution, has been described using detailed descriptions of embodiments thereof that are provided by way of example and are not intended to limit the scope of the disclosure. The described embodiments comprise different features, not all of which are required in all embodiments of a kamado cooker that looks like an iconic kettle-style grill. Some embodiments of the solution utilize only some of the features or possible combinations of the features. Variations of embodiments of the solution that are described and embodiments of the solution comprising different combinations of features noted in the described embodiments will occur to persons of the art.

It will be appreciated by persons skilled in the art that a kamado cooker that looks like an iconic kettle-style grill according to the solution is not limited by what has been particularly shown and described herein above. Rather, the scope of a kamado cooker that looks like an iconic kettle-style grill according to the solution is defined by the claims that follow.

What is claimed is:

1. A kamado cooker that looks like an iconic kettle-style grill, comprising:
a ceramic kettle base having an exterior surface and an interior surface and defining an aperture at its bottom;
a ceramic lid hinged to the ceramic kettle base;
a kettle support bowl defining an inner concave surface and an outer convex surface and a central aperture, wherein the kettle support bowl comprises a plurality of leg support extensions associated with the outer convex surface;
a kettle securing collar defining an inner concave surface and an outer convex surface and a central aperture; and
a plurality of legs mechanically received by the plurality of leg support extensions;
wherein, when the kettle support bowl is mounted to the exterior surface of the ceramic kettle base, and the kettle securing collar is mounted to the interior surface of the ceramic kettle base, the kettle support bowl central aperture and the kettle securing collar central aperture and the ceramic kettle base aperture are concentric.

2. The kamado cooker of claim 1, further comprising an ash bucket mounted beneath the convex surface of the kettle support bowl and over its central aperture.

3. The kamado cooker of claim 1, further comprising a plurality of sidewall brackets mounted to the interior surface of the ceramic kettle base, wherein each of the sidewall brackets define an upper support surface and a lower support surface.

4. The kamado cooker of claim 3, further comprising a charcoal basket suspended from the lower support surfaces of the sidewall brackets and a cooking grate resting upon the upper support surfaces of the sidewall brackets.

5. The kamado cooker of claim 4, further comprising one or more heat deflector plates resting upon the lower support surfaces of the sidewall brackets.

6. The kamado cooker of claim 3, wherein the sidewall brackets are mounted to the ceramic kettle base by fasteners extending through the ceramic kettle base.

7. The kamado cooker of claim 1, wherein the ceramic kettle base, kettle support bowl, and kettle securing collar are mechanically assembled by fasteners that extend through the ceramic kettle base.
